(19) United States
(12) Patent Application Publication
(10) Pub. No.: US 2025/0018416 A1
(43) Pub. Date: Jan. 16, 2025

(54) COATING DEVICE AND CORRESPONDING OPERATING METHOD

(71) Applicant: Dürr Systems AG, Bietigheim-Bissingen (DE)

(72) Inventors: Frank Tietze, Bietigheim-Bissingen (DE); Susanne Beeh, Ludwigsburg (DE); Heiko Friese, Bietigheim-Bissingen (DE); Tobias Conte, Bönnigheim (DE); Sven Bitzer, Stuttgart (DE); Emrah Yilmaz, Sachsenheim (DE); Andreas Dürr, Bietigheim-Bissingen (DE); Rainer Melcher, Oberstenfeld (DE); Sandra Berndt, Ditzingen (DE); Sören Wehler, Ludwigsburg (DE); Michael Just, Sindelfingen (DE); Daniel Tino Ackermann, Ditzingen (DE)

(21) Appl. No.: 18/714,125

(22) PCT Filed: Dec. 6, 2022
(86) PCT No.: PCT/EP2022/084515

§ 371 Date: May 29, 2024

(30) Foreign Application Priority Data
Dec. 16, 2021 (DE) 10 2021 133 410.1

(51) Int. Cl. B05B 13/04; B05B 15/50; B05B 16/40

(52) U.S. Cl. CPC B05B 13/0431; B05B 15/50; B05B 16/40

(57) ABSTRACT

The disclosure relates to a coating device for coating components with a coating agent. The coating device according to the disclosure comprises a coating booth and at least one separate maintenance cabin for carrying out maintenance measures within the maintenance cabin. The disclosure provides special access protection for the maintenance cabin. The disclosure further includes a corresponding operating method.

### CROSS-REFERENCE TO RELATED APPLICATIONS

This application is a national stage of, and claims priority to, Patent Cooperation Treaty Application No. PCT/EP2022/084515, filed on Dec. 6, 2022, which application claims priority to German Application No. DE 10 2021 133 410.1, filed on Dec. 16, 2021, which applications are hereby incorporated herein by reference in their entireties.

### TECHNICAL FIELD

The disclosure relates to a coating device for coating components (e.g. motor vehicle body components) with a coating agent (e.g. paint). Furthermore, the disclosure relates to a corresponding operating method for such a coating device.

### BACKGROUND

In modern painting installations for painting motor vehicle body components, rotary atomizers are usually used as application device, which are guided by a painting robot over the component surfaces to be painted. The vehicle body components to be painted are usually conveyed by a linear conveyor through a painting booth in which several painting robots and several handling robots (hood-opening robots and door-opening robots) are located on both sides of the linear conveyor.

A further development of such painting installations is known from WO 2021/063444 A1. Here, several maintenance cabins (“cubicles”) are located in the corners of the painting booth, which are separated from the painting booth and enable maintenance or cleaning measures to be carried out on robots within the respective maintenance cabin.

For this purpose, the individual maintenance cubicles each have a maintenance window, whereby the robots located in the painting booth can insert their robot arm into the maintenance cubicle through the maintenance window of the maintenance cubicle. For example, external charging rings for electrostatic external charging can be replaced in the maintenance cabins in this way. Another example of a maintenance measure inside the maintenance cabin is that the rotary atomizer or handling tools of a handling robot can be cleaned in the maintenance cabin.

The respective maintenance or cleaning measure in the maintenance cabin can be carried out by an operator who can enter the maintenance cabin through an access door. However, operational safety is problematic here if an operator is present in the maintenance cabin.

Furthermore, reference should also be made to DE 102 37 747 A1, EP 3 140 043 B1 and DE 11 2019 002 282 T5 for the technical background of the disclosure.

The disclosure is therefore based on the task of improving the above-described known coating device accordingly and of specifying an associated operating method.

### BRIEF DESCRIPTION OF THE DRAWINGS

FIG. 1 shows a cut-away perspective view of a painting booth according to the disclosure.

FIG. 2 shows a top view of the painting booth from FIG. 1.

FIG. 3A shows a window closure for closing a maintenance window of a maintenance cabin, the window closure being in an open position.

FIG. 3B shows the window closure from FIG. 3A in a cleaning position when cleaning a painting robot.

FIG. 3C shows the window closure from FIG. 3A in a cleaning position for cleaning a door opener robot designed as a SCARA robot.

FIG. 3D shows the window closure from FIG. 3A in a closed position in which the maintenance window of the maintenance cabin is closed.

FIG. 4 shows a perspective view of a maintenance cabin with a pivotable atomizer cleaning device.

FIG. 5 shows a simplified schematic representation of the coating device according to the disclosure with a control system.

FIG. 6 shows a schematic representation of a control panel on the painting booth.

FIG. 7 shows a flow chart to illustrate the walk-in protection according to the disclosure for the maintenance cabin.

FIG. 8 shows a flowchart to illustrate the control of access to the maintenance cabin for the robots.

FIG. 9 shows a flowchart to illustrate an automatic operation.

FIG. 10 shows a flowchart to illustrate a painting robot cleaning operation.

FIG. 11 shows a flowchart to illustrate a handling robot cleaning operation.

FIG. 12 shows a flowchart to illustrate an automated cleaning operation for the atomizer cleaning device.

FIG. 13 shows a flowchart to illustrate an observation operation.

FIGS. 14A and 14B show a modification of FIGS. 3A-3D.

FIG. 15 shows a further modification of FIGS. 3A-3D.

FIG. 16 shows a modification of FIG. 4.

### DETAILED DESCRIPTION

The coating device according to the disclosure is designed for coating components, which may be, for example, motor vehicle body components. However, the disclosure is not limited to motor vehicle body components with respect to the type of components to be coated.

In this case, the components to be coated (e.g. motor vehicle body components) are coated with a coating agent, which may preferably be a paint. However, with regard to the coating agent to be applied, the disclosure is not limited to paints, but can also be implemented in a coating device which applies other types of coating agents, such as adhesives, sealants or insulating materials, to name just a few examples.

In accordance with the known coating device according to WO 2021/063444 A1 described at the beginning, the coating device according to the disclosure also comprises a coating booth (e.g. painting booth) which accommodates the components to be coated during coating, the coating booth preferably having booth walls which are impermeable to the applied coating agent.

The components to be coated are preferably transported through the coating booth by a conveyor, as is known from the prior art. Within the scope of the disclosure, however, driverless transport systems (DTS) can also be used as conveyors, whereby these are floor-bound conveyors with their own travel drive that are controlled automatically. Such conveyors are also referred to as driverless transport vehicles (AGVs) or automated guided vehicles (AGVs).

Furthermore, in accordance with the known coating device described at the beginning, the coating device according to the disclosure comprises at least one robot arranged in the coating booth.

For example, a coating robot (e.g., painting robot) may be arranged in the coating booth to coat the components with the coating agent (e.g., paint), wherein the coating robot guides an applicator (e.g., rotary atomizer, print head) to apply the coating agent.

Furthermore, a handling robot can be arranged in the coating booth, which is used to handle the components to be coated. For example, the handling robot can be a door-opening robot that opens and closes the doors of the motor vehicle body components to be coated. Another example of a handling robot is hood opener robots that are used to open and close the hoods (e.g., hood, trunk lid) of the motor vehicle body components.

In an embodiment of the disclosure, not only a single robot is arranged in the coating booth. Rather, there are several coating robots in the coating booth, preferably arranged on either side of the linear conveyor. Furthermore, there are preferably also several handling robots (e.g. hood opener robots, door opener robots) in the coating booth, which can also be arranged on both sides of the linear conveyor. For example, two painting robots, two door-opening robots and two hood-opening robots can be arranged on each side of the linear conveyor, so that there are a total of twelve robots in the painting booth.

In accordance with the known coating device according to WO 2021/063444 A1 described at the beginning, the coating device according to the disclosure also has at least one maintenance cabin (“cubicle”), which is used to carry out maintenance measures on the at least one robot, wherein the respective maintenance measure can be carried out in the maintenance cabin.

The term of a maintenance measure used in the context of the disclosure is to be understood in a general sense and also includes, for example, cleaning processes, such as, for example, cleaning of the applicator (e.g., rotary atomizer, print head) or cleaning of hand-held tools of the handling robot. Furthermore, the concept of a maintenance measure used in the context of the disclosure also includes, for example, the replacement or discarding of an external charging ring used for electrostatic external charging. For example, an external charging ring for external painting can be replaced by an external charging ring for internal painting, to give just one example.

In this case, the maintenance cabin has a closable maintenance window, whereby the robot can insert its robot arm at least partially through the maintenance window into the maintenance cabin so that the maintenance measure can then be carried out in the maintenance cabin.

Furthermore, the maintenance cabin has an access door through which an operator can enter the maintenance cabin.

Furthermore, the coating device according to the disclosure also has a control system for controlling the operation of the coating device. The term control system used in the context of the disclosure is also to be understood in a general sense and is not limited to a single component. Rather, the control system in the coating device according to the disclosure can also be distributed over various control components and can be implemented optionally as hardware or software.

The disclosure is now characterized by a special walk-in protection for the maintenance cabin in order to increase operational safety. During operation, for example, there is a risk that a maintenance measure in the maintenance cabin could lead to injury to an operator in the maintenance cabin.

In the coating device according to the disclosure, the control system therefore only allows access through the access door into the maintenance cabin for the operator if there is no danger to the operator. This is the case when the maintenance window of the maintenance cabin is closed and/or when all robots in the coating booth are switched off and are in a safe operating state without potential danger.

In addition, the control system preferably controls access through the maintenance window into the maintenance cabin for the robots. Thus, the control system allows access through the maintenance window into the maintenance cabin for the robot only if this cannot lead to any danger to an operator. This condition is fulfilled when the access door to the maintenance cabin is closed and preferably also locked.

In the preferred embodiment of the disclosure, the maintenance cabin also has a door sensor that detects the opening state of the access door, the door sensor preferably reporting the opening state of the access door to the control system.

In addition, the maintenance cabin may have a controllable door lock that prevents the access door from opening in a locked state, so that the access door can only be opened in an unlocked state. The door lock is preferably controlled by the control system, which thus interrogates the door sensor and controls the door lock in order to control access to the maintenance cabin.

It has been mentioned above that the maintenance cabin has a maintenance window so that the robot can insert its robot arm at least partially through the maintenance window into the maintenance cabin. In the preferred embodiment of the disclosure, this maintenance window comprises an adjustable window closure for selectively opening or fully or partially closing the maintenance window, the window closure preferably being controlled by the control system.

For example, this window closure can have a movable or pivotable closure plate which, depending on its position, opens or completely or partially closes the maintenance window.

The movable or pivotable closure plate can have a cutout that is adapted to the cross section of a robot arm of the robot, so that the closure plate can close the maintenance window down to the robot arm when the robot arm projects through the maintenance window into the maintenance cabin. The cutout in the closure plate thus makes it possible to close the maintenance window almost completely even when the robot arm of the respective robot is guided through the maintenance window into the maintenance cabin. It is also possible for the cutout in the closure plate to taper from the edge of the closure plate, in particular in the form of a triangle or a semicircle.

It is possible for the closure plate of the window closure to be transparent so that an operator can observe processes in the coating booth through the closure plate from the maintenance cabin. This also enables an observation mode in which no maintenance measures are carried out in the maintenance cabin. Rather, in this observation mode, there is an operator in the maintenance cabin who can observe the coating operation in the coating booth through the transparent closure plate, whereby the closure plate then closes the maintenance window. It should be mentioned here that not only the closure plate itself can be transparent, but also the cabin walls of the maintenance cabin. Furthermore, within the scope of the disclosure, it is also possible that the closure plate is opaque, whereas the cabin walls of the maintenance cabin are transparent.

The window closure described above is preferably adjustable between different positions, namely between an open position, a closed position and a cleaning position.

In the open position, the window closure opens the maintenance window of the maintenance cabin substantially in its entirety, so that the robot to be maintained can move its robot arm through the maintenance window into the maintenance cabin without hindrance, so that the respective maintenance measure can then be carried out in the maintenance cabin.

In the closed position, on the other hand, the window closure closes the maintenance window of the maintenance cabin essentially completely, so that the operator can remain in the maintenance cabin while the components are being coated in the coating booth.

In the cleaning position, on the other hand, a robot arm of the respective robot protrudes through the maintenance window into the maintenance cabin, with the window closure then closing the maintenance window down to the contour of the robot arm.

It has already been mentioned above that the maintenance cabin has an access door through which an operator can enter or leave the maintenance cabin.

In one variant of the disclosure, the access door connects the maintenance cabin with the coating booth, i.e. the maintenance cabin is entered through the access door from the interior of the coating booth.

In another variant of the disclosure, on the other hand, the access door of the maintenance cabin connects the maintenance cabin with an exterior space outside the coating booth, so that the maintenance cabin can be entered through the access door from outside the coating booth. This is advantageous because the maintenance cabin can then be entered without first having to enter the coating booth.

In the preferred embodiment of the disclosure, the coating device comprises a maintenance device to perform a maintenance operation.

For example, this may be an applicator cleaning device used to clean the applicator (e.g. rotary atomizer, print head). For this purpose, the applicator cleaning device may have an insertion opening for inserting the applicator (e.g., atomizer) to be cleaned into the applicator cleaning device and then cleaning it within the applicator cleaning device. Such atomizer cleaning devices are known per se from the prior art and are described, for example, in DE 10 2014 016 364 A1, EP 1 671 706 B1 and EP 2 643 096 B1.

However, the maintenance device can also be a jet testing device for testing the coating agent jet emitted by the applicator designed as a print head. Such a jet testing device is also known from the prior art and is described, for example, in DE 10 2019 135 360 A1, EP 3 689 474 A1 and EP 3 890 895 A1.

Furthermore, it is also possible that the maintenance device is a cleaning device used for cleaning handling tools of the handling robot.

In this case, the maintenance device is preferably mounted in a pivot opening in a booth wall of the maintenance cabin and can be pivoted by means of a pivoting mechanism between an operating position inside the coating booth and a maintenance position inside the maintenance cabin, the pivoting preferably taking place about a vertical or horizontal pivot axis. In the case of an atomizer cleaning device as a maintenance device, the atomizer cleaning device is pivoted outwardly into the coating booth for cleaning the atomizer so that the rotary atomizer can then be inserted into the atomizer cleaning device. To carry out a maintenance measure on the atomizer cleaning device, it is then pivoted inward into the maintenance cabin.

The pivoting mechanism for the pivoting maintenance unit is preferably designed in such a way that the pivot opening in the cabin wall of the maintenance cabin is closed by the pivoting mechanism both in the operating position and in the maintenance position. For this purpose, the pivoting mechanism can have two closure plates which are angled towards each other, one closure plate closing the pivot opening in the operating position, while the other closure plate closes the pivot opening in the maintenance position. For this purpose, the two closure plates can be angled at a fixed angle to one another and pivot together, the angle between the two closure plates preferably being substantially 90°.

Furthermore, it is possible that a handle is attached to the maintenance device in order to be able to pull the maintenance device from inside the maintenance cabin into the maintenance cabin.

Further, the pivoting mechanism may include a damper to dampen the pivoting motion of the maintenance device.

Further, the maintenance cabin may include a door open button to open the access door. If an operator wishes to enter the maintenance cabin, the operator must press the door open button, whereupon the control system then releases the access door into the maintenance cabin, provided that the access protection according to the disclosure allows this.

Furthermore, the maintenance cabin can have an acknowledgement button to acknowledge that the operator has left the maintenance cabin. Thus, the operator must press the acknowledge button after leaving the maintenance cabin so that the walk-through guard can then allow access through the maintenance window for the robot again. The door open button and the acknowledgement button are therefore preferably connected to the control system.

Furthermore, it should be mentioned that in the preferred embodiment of the disclosure, the maintenance cabin can be operated in several different modes to ensure the safety of the operator during operation. An operating mode selector switch can be assigned to the maintenance cabin in order to select the respective operating mode of the maintenance cabin. In the preferred embodiment of the disclosure, the maintenance cabin can be operated in at least one of the following operating modes, which will be described in detail later:
Automatic mode,
coating robot cleaning operation to clean the coating robot,
handling robot cleaning operation for cleaning the handling robot,
accessory cleaning operation for cleaning accessories, especially the applicator cleaning device or an external charging ring for an atomizer for external electrostatic charging of the applied coating agent,
observation operation for observing processes in the coating booth.

In the automatic mode, a check is preferably made automatically to determine whether a maintenance measure needs to be carried out. The control system checks whether there is a maintenance request for a coating robot or a handling robot. The maintenance request can be triggered by a user or generated automatically. In the event of a maintenance request, the control system then performs several or all of the following steps, in particular in the following sequence:
Terminating the coating operation at the coating robot to be cleaned,
discharging the electrostatic coating agent charging system at the coating robot to be cleaned, if an electrostatic coating agent charging system is provided,
locking the access door to the maintenance cabin to prevent opening of the access door and entering the maintenance cabin, if the access door is not already locked (for this step, it should be mentioned that the access door to the maintenance cabin can be permanently locked in the automatic mode),
opening the maintenance window of the maintenance cabin,
inserting the robot to be cleaned with its robot arm through the opened maintenance window into the maintenance cabin,
closing the maintenance window of the maintenance cabin into the cleaning position,
changing the operating mode of the maintenance cabin from automatic mode to cleaning mode, unlocking the access door to the maintenance cabin to allow the operator to enter the maintenance cabin,
performing a cleaning action in the maintenance cabin,
acknowledging after the operator has left the maintenance cabin and closed the access door, locking the access door to the maintenance cabin, changing the operating mode of the maintenance cabin to,
acknowledging the locking of the access door to the maintenance cabin by the maintenance person after leaving the maintenance cabin,
opening the maintenance window of the maintenance cabin,
moving the robot out of the maintenance cabin through the open maintenance window, and finally,
closing the maintenance window of the maintenance cabin.

Regarding the automatic operation described above, it should be mentioned that preferably no operator is required. The robot preferably does everything on its own (e.g. changing the external charge). The closure plate (disc) preferably remains open. No human may enter the maintenance cabin (“cubicle”) during this process, as the robot is not safely switched off. In comparison, an operator must enter the maintenance cabin (“cubicle”) in cleaning mode. Therefore, the robot must then be safely switched off and the window must be closed for safety reasons.

With the coating robot cleaning operation briefly mentioned above, on the other hand, it is checked whether there is a cleaning request for a coating robot on the part of the user. For example, an operator can request a cleaning process if the operator detects contamination of the coating robot. In the event of such a cleaning request from the user, the control system then preferably controls the coating device in such a way that several or all of the following steps are carried out, and preferably in the following order:
Changing the operating mode of the maintenance cabin (“Cubicle”) from automatic mode to cleaning mode, requesting the corresponding robot, terminating the coating operation at the coating robot to be cleaned,
uncharging the electrostatic coating agent charging system at the coating robot to be cleaned, if an electrostatic coating agent charging system is provided,
locking the access door (cf. above remark on automatic operation) to the maintenance cabin to prevent the access door from being opened and the maintenance cabin from being entered, if the access door is not already locked,
opening the maintenance window of the maintenance cabin,
Inserting the coating robot to be cleaned through the open maintenance window into the maintenance cabin,
closing the maintenance window of the maintenance cabin into the cleaning position,
switching off the coating robot to put it into a safe operating state in which no danger emanates from the coating robot,
unlocking the access door to the maintenance cabin to allow the operator to enter the maintenance cabin,
performing a cleaning operation in the maintenance cabin,
acknowledging after the operator has left the maintenance cabin and closed the access door, locking the access door in the maintenance cabin, changing the operating mode of the cubicle to automatic mode, locking the access door in the maintenance cabin after the operator has left the maintenance cabin and closed the access door,
acknowledging the locking of the access door to the maintenance cabin by the operator after leaving the maintenance cabin,
opening of the maintenance window of the maintenance cabin,
moving the coating robot out of the maintenance cabin through the open maintenance window, and finally
closing the maintenance window of the maintenance cabin.

In the handling robot cleaning mode briefly mentioned above, a check is made to determine whether a user has requested cleaning of a handling robot. For example, an operator can request such cleaning if the operator detects contamination of a handling robot. The control system then controls the coating device to clean the handling robot accordingly, whereby the aforementioned steps for cleaning the coating robot are performed accordingly for cleaning the handling robot.

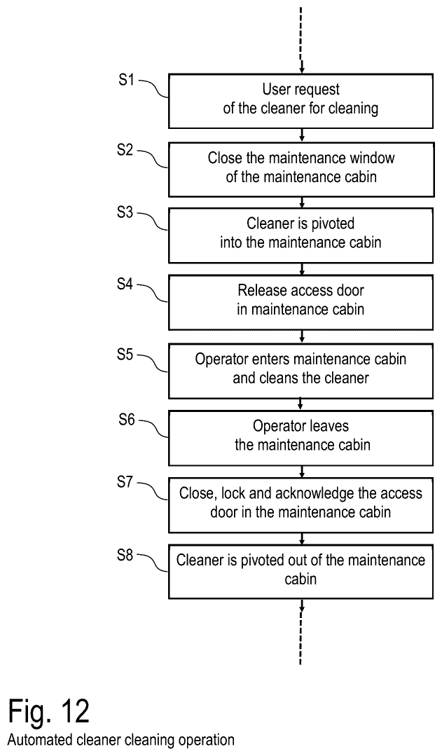

In the aforementioned accessory cleaning mode, however, the pivotable maintenance device (e.g., atomizer cleaning device) is pivoted into the maintenance position inside the maintenance cabin in order to be able to service the maintenance device inside the maintenance cabin. Preferably, the door lock of the access door of the maintenance cabin is unlocked so that an operator can enter the maintenance cabin and perform the maintenance measure on the maintenance device. In the current manual process, access is requested when all conditions are met, then unlocked, and then the cleaner is swung into the maintenance cabin (“cubicle”) by the operator. In an automated operation, this would be as described, first swinging the cleaner, then access, unless the swinging was safe, in which case it would go the other way. FIG. 12 illustrates this automated operation.

It was already mentioned above that in the coating device according to the disclosure, several robots are arranged within the coating booth. The different types of robots (coating robots, hood opener robots, door opener robots) are preferably vertically distributed and arranged one above the other in different levels.

The hood opener robots are preferably located in an upper level in order to open and close hoods (e.g. hood, trunk lid) of the motor vehicle bodies, with the hood opener robots preferably being movable on an upper travel rail. The upper arrangement of the hood opener robots allows them easy and largely undisturbed access to the hoods of the motor vehicle bodies that can be opened.

The coating robots, on the other hand, are preferably located in a middle level in the coating booth and can preferably be moved along a middle travel rail. The middle arrangement of the coating robots also enables them to operate largely undisturbed.

On the other hand, the door opener robots, which open or close the doors of the motor vehicle bodies, are preferably located in the lower level in the coating booth, with the door opener robots preferably being designed as SCARA robots (SCARA: Selective Compliance Assembly Robot Arm). and can be moved, for example, along a lower travel rail. This lower arrangement of the door opener robots allows them largely undisturbed access to the doors to be opened.

It should also be mentioned that the maintenance window of the maintenance cabin is preferably arranged at such a height that all types of robots (hood opener robots, coating robots, door opener robots) can all drive into the maintenance cabin with their robot arm through the maintenance window.

Furthermore, it should be generally mentioned that the coating booth preferably has a rectangular floor plan, with a maintenance cabin being arranged in each of the four corners of the coating booth, as is basically known from the patent publication WO 2021/063444 A1 already mentioned above is. The maintenance cabin (“Service Cubicle”) could also be located between two stations, where it can be accessed from both sides.

The coating robots and the handling robots can either be mounted stationary or movable along a travel rail.

Furthermore, it should be mentioned that the applicator is preferably an atomizer, such as a rotary atomizer. However, within the scope of the disclosure, there is also the alternative possibility that the applicator is a so-called print head, which applies the coating agent almost without overspray (i.e. with an application efficiency of almost 100%) and does not use a spray jet of the coating agent, but rather spatially narrowly limited coating agent jets. Such print heads have been developed recently and are described, for example, in EP 2 953 732 B1, EP 2 566 627 B1, EP 311 217 6B1, EP 3 554 714 A1, WO 2018/108 572 A1, WO 2018/108 568 A1 and EP 3 698 881 A1.

Furthermore, it should be mentioned that the maintenance cabin can have a fresh air purging system, which purges the maintenance cabin with fresh air in order to ensure a breathable atmosphere in the maintenance cabin when the coating agent is applied in the coating booth. This is particularly advantageous in the observation operation when an operator observes in the maintenance cabin while the coating agent is being applied in the coating booth.

In addition to the coating device according to the disclosure described above, the disclosure also claims protection for a corresponding operating method. The individual process steps of the operating method according to the disclosure are already apparent from the above description of the coating device according to the disclosure, so that a separate description of the operating method according to the disclosure can be dispensed with.

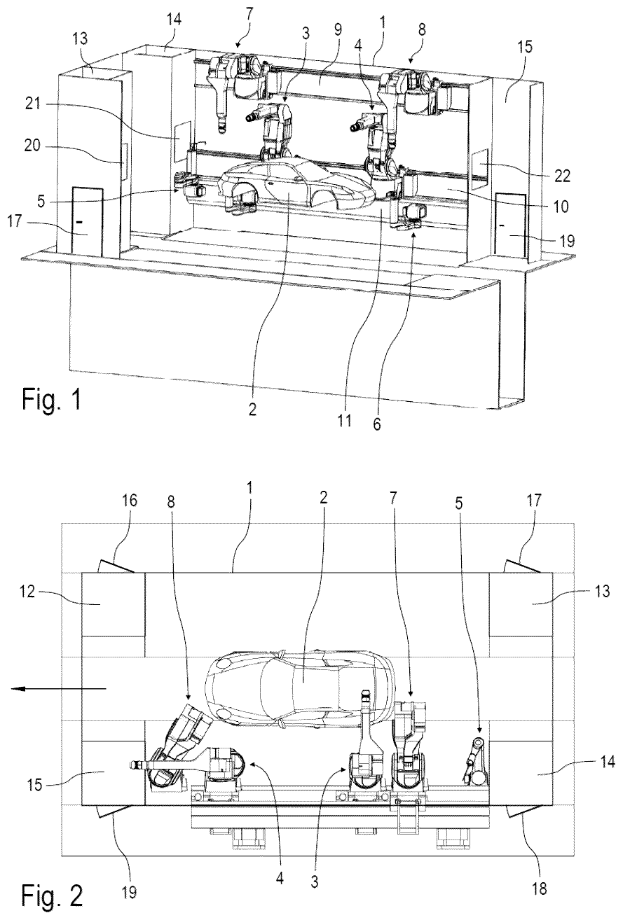

In the following, the exemplary embodiment according to FIGS. 1 and 2 will first be described, which show a painting booth 1 according to the disclosure, in which motor vehicle bodies 2 are painted, the motor vehicle bodies 2 to be painted being transported by a linear conveyor (not shown) in the direction of the arrow through the painting booth 1.

In the painting booth 1 there are two painting robots 3, 4 on both sides of the linear conveyor, each of which guides a rotary atomizer (not shown) as an application device over the surfaces of the motor vehicle body 2.

In addition, two door opener robots 5, 6 are arranged in the painting booth 1 on both sides of the linear conveyor, which are designed as SCARA robots and have the task of opening or closing the doors of the motor vehicle body 2 to be painted, so that the interior of the motor vehicle body 2 can be painted.

Furthermore, two hood opener robots 7, 8 are arranged in the painting booth 1 on both sides of the linear conveyor, which have the task of opening hoods and trunk lids of the motor vehicle bodies 2 in order to be able to paint the motor vehicle body 2 in its interior.

The hood opener robots 7, 8 are arranged in the painting booth 1 in an upper level and can be moved along an upper travel rail 9 parallel to the linear conveyor.

The painting robots 3, 4, on the other hand, are arranged in a middle level in the painting booth 1 and can be moved along a middle travel rail 10 parallel to the linear conveyor.

The door opener robots 5, 6, on the other hand, are arranged in the painting booth 1 on a lower level and can be moved along a lower travel rail 11.

The distribution of the different types of robots (painting robots 3, 4, door opener robots 5, 6 and hood opener robots 7, 8) on three levels one above the other is advantageous because the different types of robots only minimally interfere with each other.

In each of the four corners of the painting booth 1 there is a maintenance cabin 12, 13, 14, 15, the maintenance cabins 12-15 being separated from the rest of the painting booth 1 by booth walls.

The maintenance cabins 12-15 are each accessible to operators through an access door 16-19, with the access doors 16-19 allowing access to the maintenance cabins 12-15 from the outside without having to enter the painting booth 1.

In addition, the maintenance cabins 12-15 each have a maintenance window 20-22, whereby the maintenance windows 20-22 serve to ensure that the different types of robots in the painting booth 1 can move their robot arm through the maintenance windows 20-22 into the respective maintenance cabin in order to carry out a maintenance or cleaning measure there, as will be described in detail.

For example, a maintenance measure can consist of the painting robot 3 depositing or replacing an external charging ring in the maintenance cabin 14. For this purpose, the painting robot 3 is moved along the travel rail 10 in the direction of the maintenance cabin 14 and then inserted with its robot arm through the maintenance window 21 into the maintenance cabin 14, so that the external charging ring in the maintenance cabin 14 can then be replaced or changed.

In addition, for example, the door opener robot 5 can also be introduced with its robot arm through the maintenance window 21 into the maintenance cabin 14 so that a handling tool of the door opener robot 5 is cleaned inside the maintenance cabin 14.

Furthermore, the maintenance cabins 12-15 enable an observation operation in which an operator is located in one of the maintenance cabins 12-15 and then observes the painting operation in the painting booth 1 through the maintenance windows 20-22.

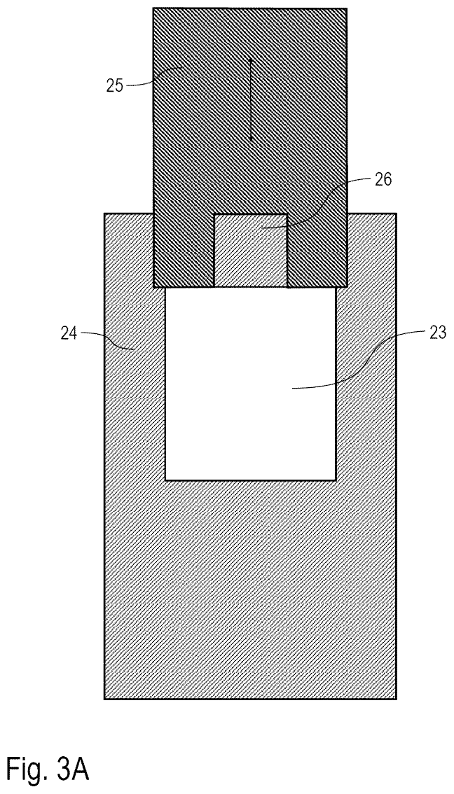

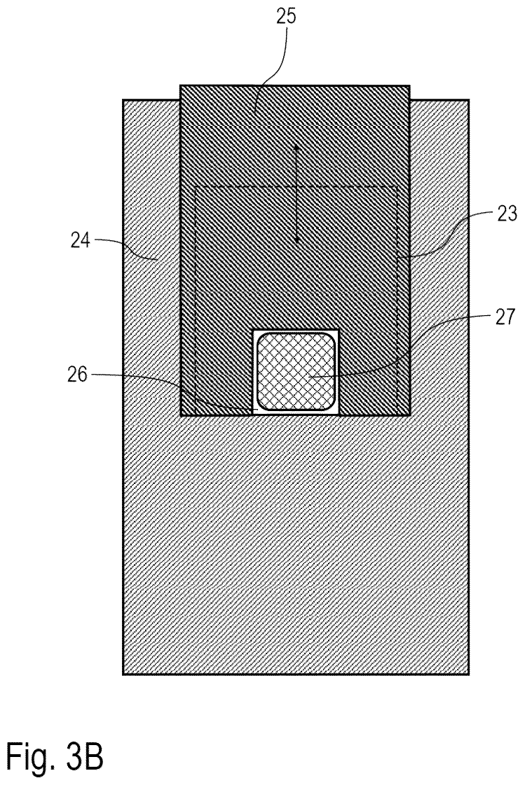

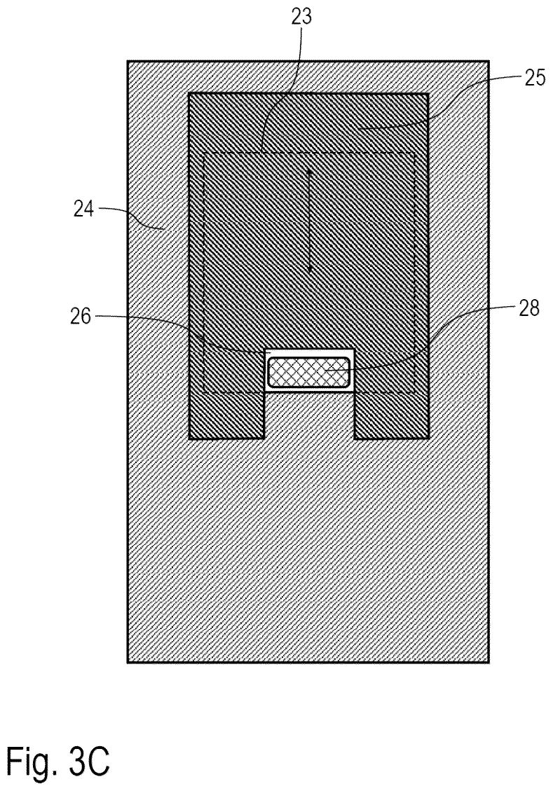

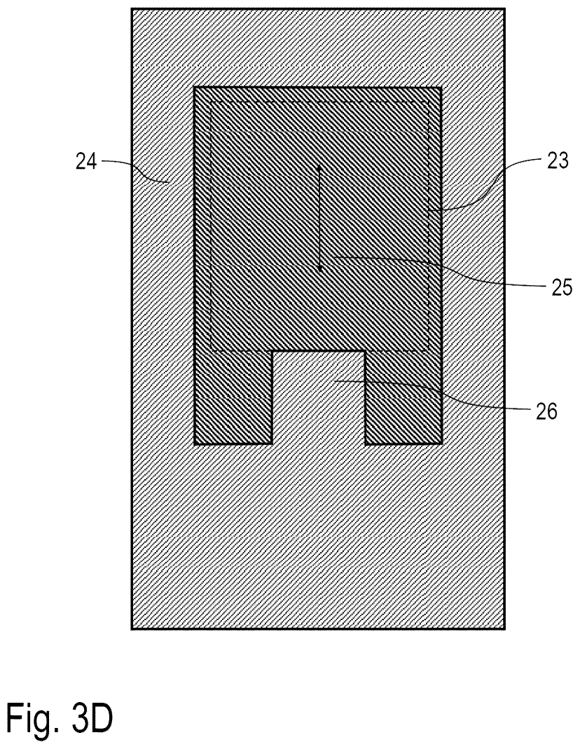

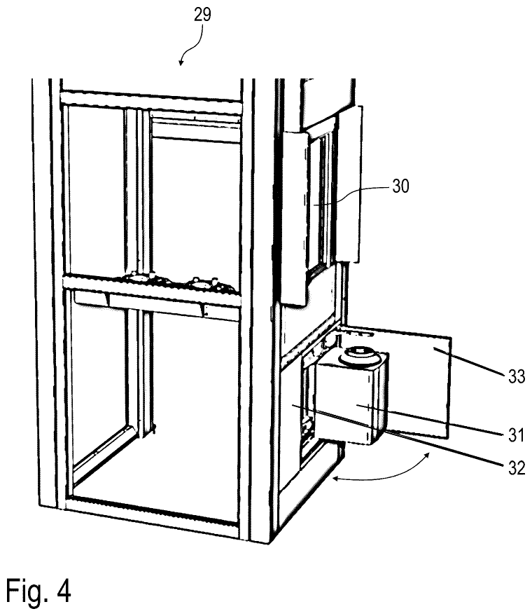

FIGS. 3A-3D will now be described below, which show a window closure for a maintenance window 23, as described above with reference to FIGS. 1-2, the maintenance window 23 being arranged in a cabin wall 24 of a maintenance cabin.

The window closure essentially consists of a closure plate 25, which is displaceable in the direction of the arrow, wherein the displacement of the closure plate 25 can be driven, for example, by an electric motor which is controlled by a control system of the painting device, as will be described in detail.

In the closure plate 25 there is a cutout 26 at the lower end, which is adapted to the cross-section of a robot arm 27, the meaning of the cutout 26 being described in more detail.

FIG. 3A shows the window closure in an open position in which the closure plate 25 has moved all the way up and therefore completely exposes the maintenance window 23 in the cabin wall 24. This enables a robot to move its robot arm 27 through the maintenance window 23 into the maintenance cabin in order to carry out a maintenance or cleaning measure there.

FIG. 3B shows the window closure in a cleaning position in which the closure plate 25 has moved downwards, with the robot arm 27 of a robot to be cleaned protruding through the cutout 26 in the closure plate 25 into the maintenance cabin. The closure plate 25 closes the maintenance window 23 almost completely, since the shape of the cutout 26 is adapted to the outer contour of the robot arm 27.

FIG. 3C shows a corresponding cleaning position for cleaning on a SCARA robot, which has a slimmer robot arm 28. Even in this cleaning position, the closure plate 25 closes the maintenance window 23 almost completely.

Finally, FIG. 3D shows a closed position of the window closure, in which the closure plate 25 has moved all the way down and completely closes the maintenance window 23. It should be mentioned here that the closure plate 25 is transparent. This offers the advantage that an operator in the maintenance cabin can observe the painting process in the painting booth 1 through the transparent closure plate 25 even in the closed position according to FIG. 3D.

The perspective view according to FIG. 4 will now be described below, which shows a maintenance cabin 29 with a maintenance window 30, the technical meaning of the maintenance window 30 having already been described above.

Below the maintenance window 30 there is a pivot opening in the cabin wall of the maintenance cabin 29, with an atomizer cleaning device 31 (“cleaner”) being pivotably mounted in the pivot opening.

The drawing shows the atomizer cleaning device 31 in an operating position in which the atomizer cleaning device 31 is pivoted out of the maintenance cabin 29 and is therefore located in the surrounding painting booth. In this cleaning position, a rotary atomizer can be inserted into the atomizer cleaning device 31 and cleaned therein.

However, the atomizer cleaning device 31 can also be pivoted inwards into the maintenance cabin 29 in the direction of the double arrow by means of a pivoting mechanism. In this internal maintenance position within the maintenance cabin 29, the atomizer cleaning device 31 can then be serviced, for example.

The pivoting mechanism for pivoting the atomizer cleaning device 31 has two closure plates 32, 33, which are arranged in a fixed angular position to one another and pivot together with the atomizer cleaning device 31. In the cleaning position shown in the drawing, the closure plate 32 closes the pivot opening in the cabin wall of the maintenance cabin 29. In the interior maintenance position, however, the other closure plate 33 closes the pivot opening in the cabin wall of the maintenance cabin 29. The pivot opening in the cabin wall of the The maintenance cabin 29 is therefore closed in both pivoting positions of the atomizer cleaning device 31. This is advantageous because it prevents paint mist (overspray) from penetrating from the painting booth into the maintenance cabin 29.

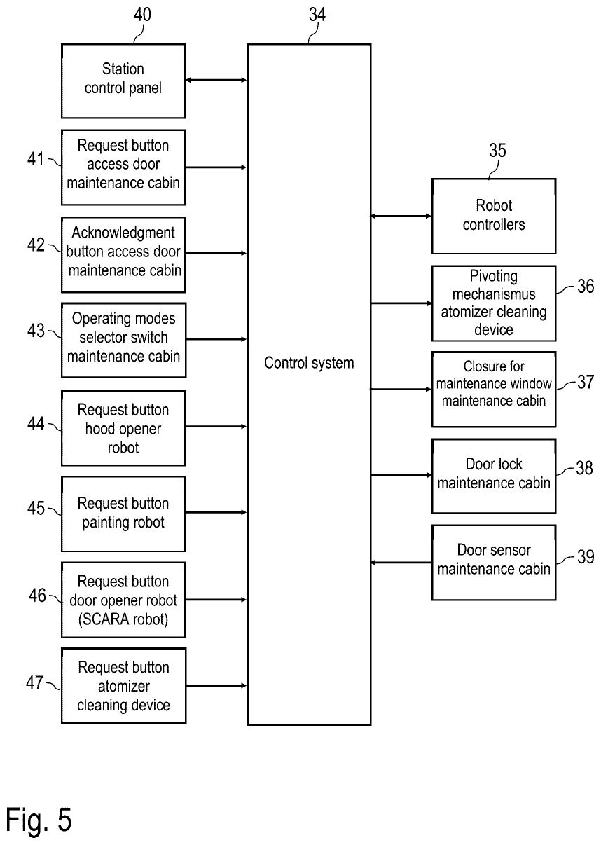

The schematic representation of a painting installation according to the disclosure according to FIG. 5 will now be described below.

The painting installation according to the disclosure has a control system 34 which controls the operation of the painting installation. It should be mentioned here that the control system 34 is shown as a single component. In practice, however, the functions of the control system 34 may be distributed across multiple components.

The control system 34 is connected to robot controllers 35, which each control a robot in the painting booth 1 according to FIGS. 1 and 2, i.e. one of the painting robots 3, 4, door opener robots 5, 6 or one of the hood opener robots 7, 8th.

In addition, the control system 34 is connected to a pivoting mechanism 36, which controls the pivoting movement of the atomizer cleaning device 31 in the exemplary embodiment according to FIG. 4.

Furthermore, the control system 34 controls a window closure 37 in each of the individual maintenance cabins 12-15, the functionality of the window closure 37 being described above with reference to FIGS. 3A-3D.

Furthermore, the control system 34 controls a door lock 38, which locks the respective access door 16-19 for the individual access doors 16-19 of the maintenance cabins 12-15 in order to prevent the respective access door 16-19 from being opened.

A door sensor 39 is arranged on the individual access doors 16-19 to the maintenance cabins 12-15, which detects the opening status of the respective access door 16-19 and reports it to the control system 34.

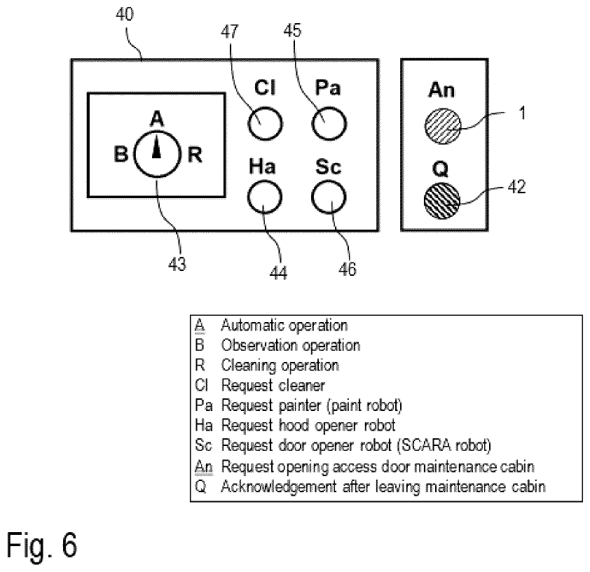

A control panel 40 is provided for user-side control of the operation, which is shown schematically in FIG. 6 and will be described in more detail. At this point it should only be briefly mentioned that the control panel 40 controls the operation of the painting booth 1.

Furthermore, a request button 41 is provided, which enables the user to request an opening of the respective access door 16-19 to the respective maintenance cabin 12-15.

Furthermore, an acknowledgment button 42 is provided, which enables an operator to acknowledge leaving the maintenance cabin 12-15 and closing the associated access door 16-19 after leaving one of the maintenance cabins 12-15, so that access to the respective maintenance cabin 12-15 can be released for the robots.

There is also an operating mode selector switch 43 on the control panel 40 to select the desired operating mode, as will be described in detail.

In addition, several request buttons 44, 45, 46 and 47 are provided in order to request a cleaning process for the various robots from the user, as will be described in detail.

FIG. 6 shows a schematic representation of the control panel 40 with the operating mode selector switch 43 and the request buttons 44-47 for requesting the different types of robots or a cleaning device for a cleaning process.

Furthermore, FIG. 6 shows the request button 41 and the acknowledgment button 42, these two buttons being provided on each of the maintenance cabins 12-15.

Regarding FIG. 6, it should be mentioned that the components shown in the drawing are preferably all provided on the respective maintenance cabin.

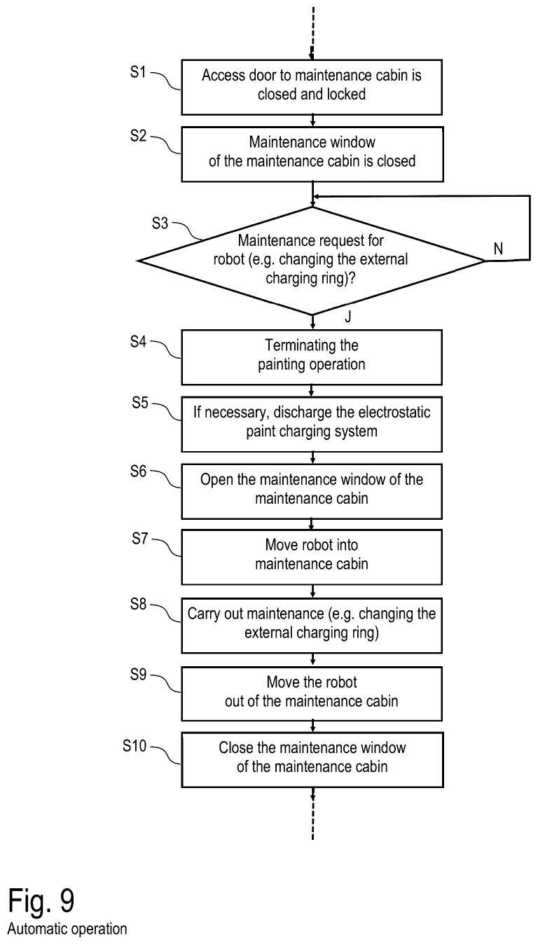

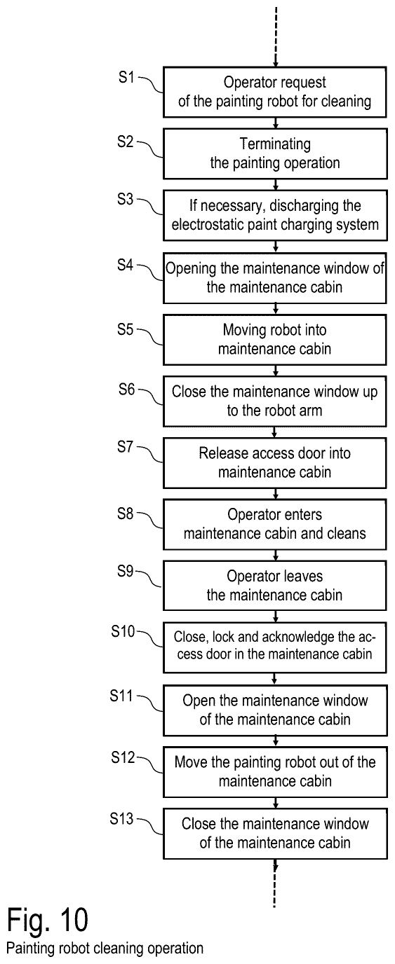

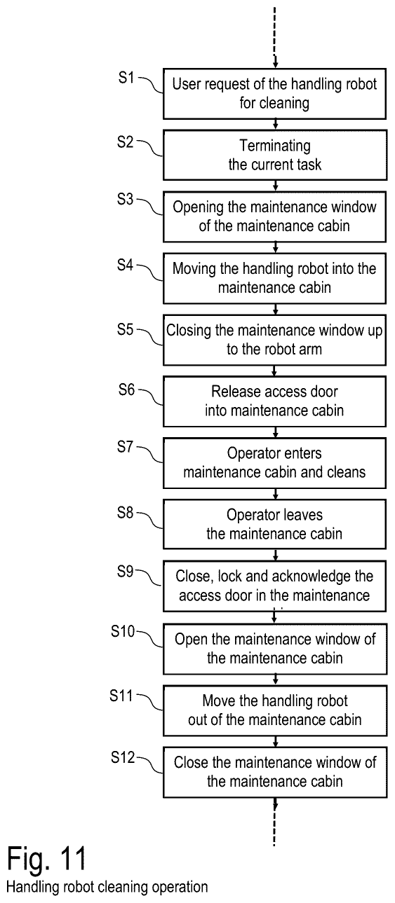

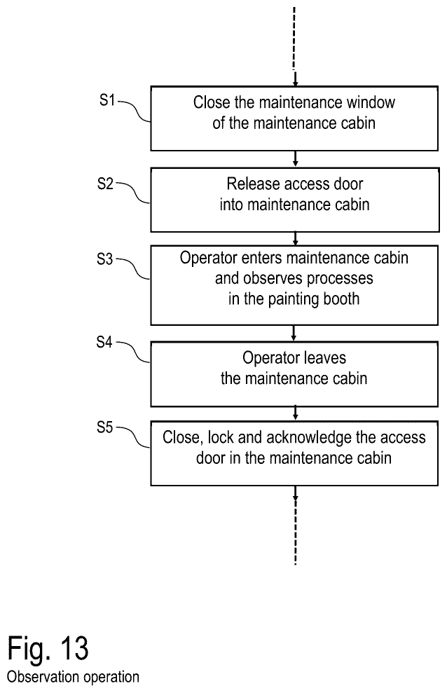

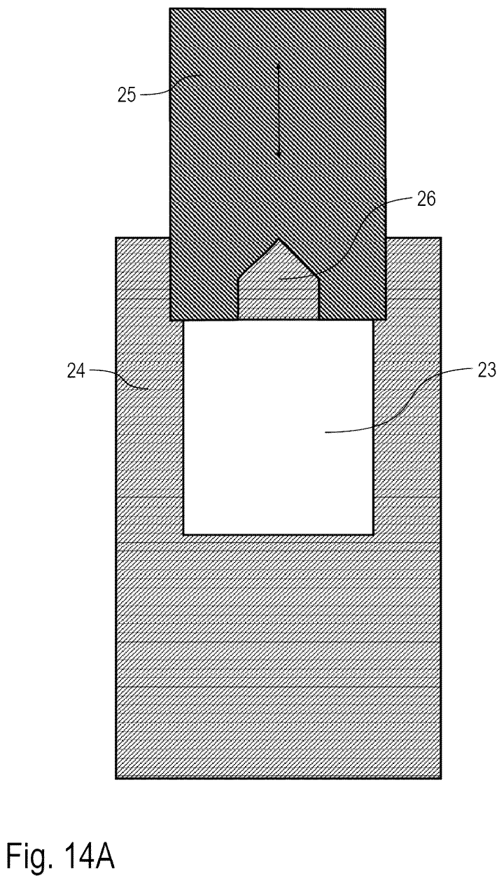

The operating mode selector switch 43 enables either an automatic mode A, an observation mode B or a cleaning mode R. The automatic mode A is shown in FIG. 9 and will be described in detail below. The cleaning operation R is shown in FIGS. 10 and 11 and will also be described in detail. Finally, the observation operation is shown in FIG. 13 and will also be described.

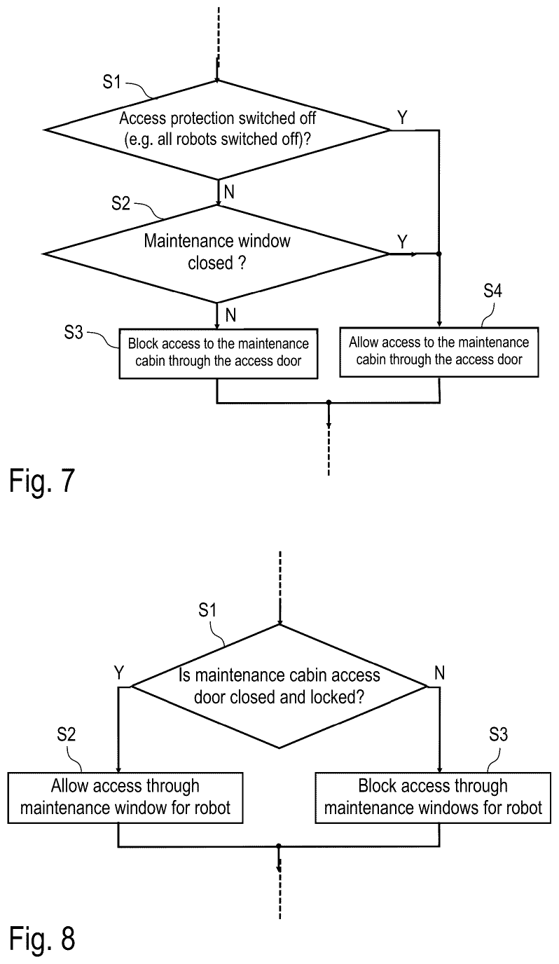

FIG. 7 shows a simplified flowchart to explain the walk-in protection according to the disclosure.

In a first step S1, it is checked whether the walk-in protection is switched off. This is the case, for example, when all robots in the painting booth are switched off and are therefore in a safe state. If this is the case, access to the respective maintenance cabin is enabled through the access door in a step S4.

Otherwise, in a step S2, it is checked whether the maintenance window of the respective maintenance cabin is closed. If this is the case, access to the respective maintenance cabin is also enabled in step S4.

Otherwise, access to the maintenance cabin is blocked through the access door in a step S3, in which the access door remains locked.

This prevents an operator in the maintenance cabin from being endangered.

FIG. 8 shows a flowchart to illustrate the walk-in protection in relation to the control of access through the maintenance windows for the robots.

In a step S1, it is checked whether the access door of the respective maintenance cabin is closed and locked and there is no operator in the maintenance cabin.

If this is the case, access through the respective maintenance window is released for the robots in a step S2.

Otherwise, in a step S3, access to the respective maintenance cabin through the maintenance window is blocked for the robots by the window closure keeping the respective maintenance window closed.

The flowchart according to FIG. 9, which explains the automatic operation, will now be described below.

In a first step S1, the access door to the respective maintenance cabin is closed and locked and there is no operator in the maintenance cabin.

In a step S2, the maintenance window of the respective maintenance cabin is then closed, provided it is not already closed.

In a step S3 it is then checked whether there is a maintenance request from one of the robots, for example to change an external charging ring of a rotary atomizer.

If this is the case, the painting operation is initially terminated in a step S4 and the electrostatic paint charge is switched off and discharged in a step S5 in order to establish a safe operating state.

In the next step S6, the maintenance window of the respective maintenance cabin is then opened.

The robot to be serviced is then moved into the respective maintenance cabin through the open maintenance window in a step S7.

In the next step S8, maintenance is then carried out in the maintenance cabin, for example by changing the external charging ring.

The next step S9 then provides for the robot to be moved out of the maintenance cabin again.

Finally, in a final step S10, the maintenance window of the maintenance cabin is closed again.

FIGS. 10 and 11 show flowcharts for cleaning a painting robot (FIG. 10) and a handling robot (FIG. 11), respectively, where the processes correspond, so that the two flowcharts are described together below. The flow chart according to FIG. 10 for cleaning the painting robot differs from the flow chart according to FIG. 11 for cleaning the handling robot only in the additional steps of discharging the electrostatic paint charge, which of course does not play a role in a handling robot.

In a first step S1, the user requests the painting robot or the handling robot for cleaning. This is done by the user pressing the associated request button 44, 45 or 46 on the control panel 40.

In the event of such a user request for a cleaning process, the painting operation or the ongoing job of the handling robot is then terminated in a step S2.

The electrostatic paint charge is then optionally discharged in a step S3, if this is provided for in the painting robot.

In the next step S4, the maintenance window of the associated maintenance cabin is then opened.

The next step S5 then provides that the robot to be cleaned is moved into the maintenance cabin through the open maintenance window and switched off in order to put the robot to be cleaned into a safe operating state without any potential hazard.

In the next step S6, the previously opened maintenance window is then closed into the cleaning position, in which the robot arm protrudes through the maintenance window into the maintenance cabin and the window closure still closes the maintenance window almost completely.

In the next step S7, the access door to the maintenance cabin is then released and in step S8 an operator can enter the maintenance cabin and clean the painting robot within the maintenance cabin.

In a next step S9, the operator then leaves the maintenance cabin again.

In the next step S10, the access door to the maintenance cabin is then closed and locked by the operator and leaving the maintenance cabin is acknowledged by pressing the Quit button.

The maintenance window of the maintenance cabin can then be opened again in a step S11.

The painting robot then moves out of the maintenance cabin again in a step S12.

Finally, in a step S13, the maintenance window of the maintenance cabin is closed.

The flowchart according to FIG. 12, which explains the automated cleaner cleaning operation, will now be described below, with reference being made to the description of FIG. 4.

In a first step S1, an operator can request cleaning of the atomizer cleaning device 31 by pressing the associated request button 47 on the control panel 40.

The associated maintenance window 30 of the maintenance cabin 29 is then closed in a step S2.

The next step S3 then provides that the atomizer cleaning device 31 is pivoted into the maintenance cabin 29.

The access door to the maintenance cabin 29 is then released in a step S4.

In the next step S5, an operator can then enter the maintenance cabin 29 and clean the atomizer cleaning device 31 in the maintenance cabin 29.

The operator then leaves the maintenance cabin 29 again in a step S6.

After leaving the maintenance cabin 29, the operator presses the associated quit button 42 and thereby reports to the control system 34 that the maintenance cabin 29 is empty.

In the next step S8, the atomizer cleaning device 31 is then pivoted out of the maintenance cabin 29 again.

Finally, the flowchart according to FIG. 13 will now be described, which explains the so-called observation mode, which can be selected on the control panel 40 by the operating mode selector switch 43 selecting the observation mode B.

In a first step S1, the maintenance window of the desired maintenance cabin is closed.

The access door to the maintenance cabin is then released in a step S2.

In the next step S3, an operator then enters the maintenance cabin and can then observe the painting processes in the painting booth from the maintenance cabin.

The operator can then leave the maintenance cabin again in a step S4 and then confirm leaving the maintenance cabin by pressing the acknowledgment button 42 in a step S5, whereupon the access door is then locked.

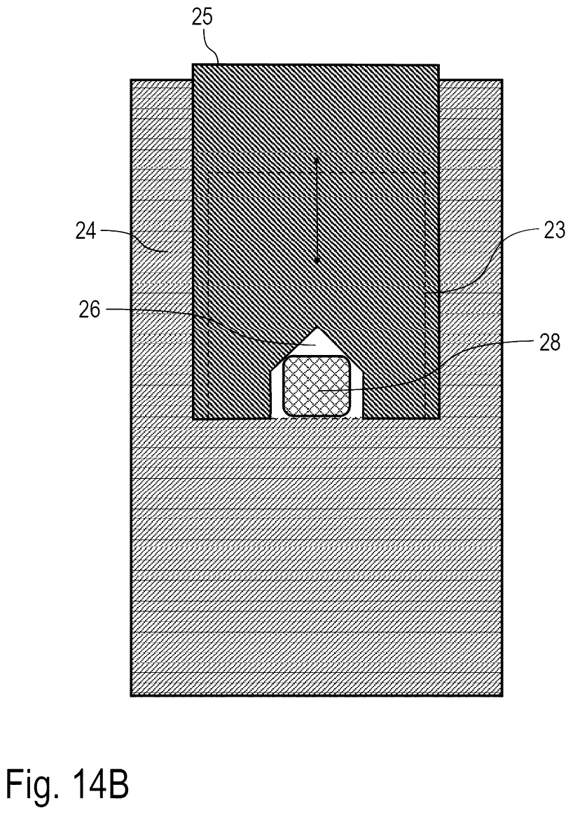

The exemplary embodiment according to FIGS. 14A and 14B will now be described below, which largely corresponds to the exemplary embodiment described above and shown in FIGS. 3A-3D, so that to avoid repetition, reference is made to the above description and for corresponding details the same reference numbers are used.

FIG. 14A shows the open state of the closure plate 25 corresponding to the state in FIG. 3A, while FIG. 14B shows the closed state of the closure plate 25 corresponding to the state in FIG. 3B.

A feature of this exemplary embodiment is the shape of the cutout 26 in the closure plate 25. The cutout 26 is not rectangular—as in the exemplary embodiment according to FIGS. 3A-3D. Instead, the cutout 26 tapers towards its upper end in the shape of a triangle. This addresses the problem that the maintenance window 23 must be suitable for different robots (types). On the one hand, the maintenance window 23 should be able to be opened so wide that the maintenance window 23 is sufficiently large for each robot, regardless of its size. On the other hand, the maintenance window 23 should not be unnecessarily large, since the free cross section must be so small due to safety regulations that it is not possible to reach through with your hand. The triangular shape of the cutout 26 in the movable closure plate 25 offers the possibility of the maintenance window 23 being closed to such an extent that, depending on the size of the robot, it is impossible to reach through with your hand. It should be mentioned here that the robot arm 27 protruding through the cutout 26 in the closure plate 25 can alternatively also have a round cross section.

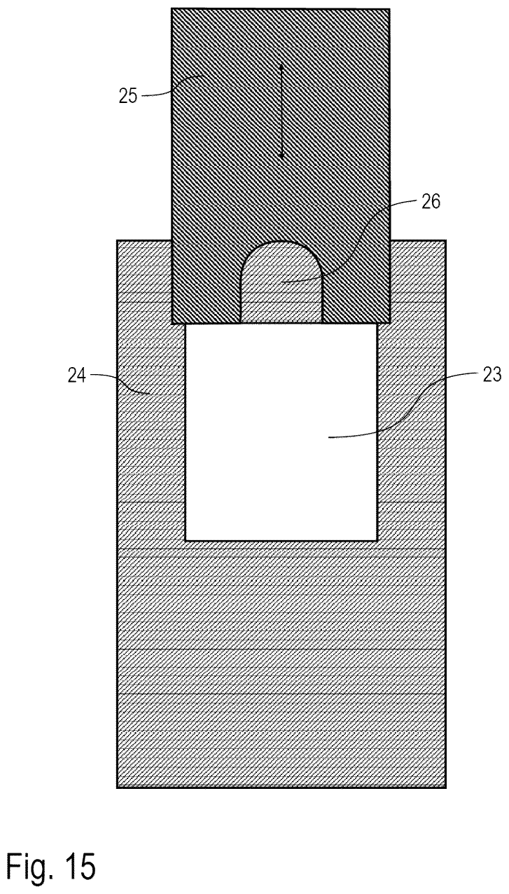

FIG. 15 shows a further modification of the exemplary embodiment according to FIG. 14, so that to avoid repetition, reference is made again to the above description, the same reference numbers being used for corresponding details.

A feature of this exemplary embodiment is that the cutout 26 in the closure plate 25 tapers in a semicircular shape towards the top. This has the same technical meaning as the taper in the form of a triangle in the exemplary embodiment according to FIG. 14, so that reference is made to the technical explanations above regarding FIG. 14.

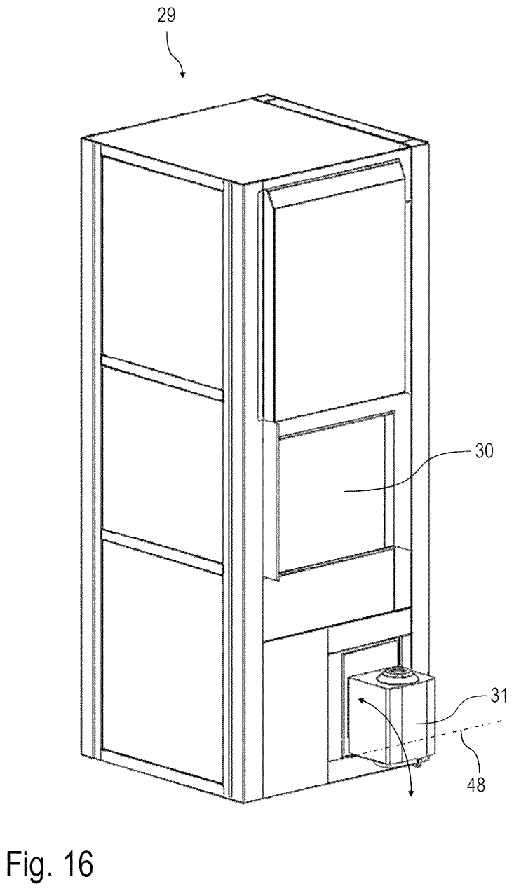

FIG. 16 shows a modification of the exemplary embodiment according to FIG. 4, so that to avoid repetition, reference is made again to the above description, with the same reference numbers being used for corresponding details.

A feature of this exemplary embodiment is that the atomizer cleaning device 31 cannot be pivoted about a vertical pivot axis, but rather about a horizontal pivot axis 48 on the underside of the atomizer cleaning device 31. The atomizer cleaning device 31 can therefore be pivoted in the direction of the double arrow about the pivot axis 48 into the maintenance cabin 29 or out of the maintenance cabin 29.

Compared with this, the embodiment shown in FIG. 4 has the disadvantage that while the atomizer cleaning device 31 is pivoted out or in, a large free space is created on the side of the atomizer cleaning device 31, which allows the hand to reach through and thus contradicts safety regulations. If, on the other hand, the atomizer cleaning device 31 is tilted about the horizontal pivot axis 48, i.e. moved from a vertical position to a position directed obliquely into the interior of the maintenance cabin 29, a free space is formed above the atomizer cleaning device 31 that is small enough to meet the safety regulations fulfill. The same applies to the reverse movement. When the atomizer cleaning device 31 is completely folded into the maintenance cabin 29 (maintenance position), its outer upper edge forms a closure (this does not have to be airtight). To fold the atomizer cleaning device 31, its holding plate is equipped with a handle directed into the maintenance cabin 29. The tilting mechanism can be equipped with a damper (similar to motion dampers on house doors). Another advantage of the tilted variant is that slightly less space is required on the outer wall of the maintenance cabin 29.

The disclosure is not limited to the preferred embodiments described above. Rather, the disclosure claims a large number of modifications and further developments that also make use of the inventive concept and therefore fall within the scope of protection. In particular, the disclosure also claims protection for the subject matter and the features of the dependent claims independently of the claims referred to in each case and in particular even without the features of the main claim. The disclosure therefore encompasses various aspects of the disclosure, which enjoy protection independently of one another. An aspect of the disclosure that is worthy of protection relates, for example, to the structural design and functionality of the window closure for closing the maintenance window of the maintenance cabin. Another aspect of the disclosure that is worthy of protection relates, for example, to the pivoting mechanism for pivoting the atomizer cleaning device into the maintenance cabin or out of the maintenance cabin.

1.-19. (canceled)

20. A coating device for coating components with a coating agent,
a) a coating booth for receiving the components to be coated during coating,
b) at least one robot arranged in the coating booth,
c) at least one maintenance cabin for carrying out maintenance measures within the maintenance cabin, the maintenance cabin
c1) is arranged within the coating booth and separated from the rest of the coating booth,
c2) has an access door through which an operator can enter the maintenance cabin, and
c3) has a maintenance window, so that the robot can introduce its robot arm at least partially through the maintenance window into the maintenance cabin, and
d) a control system for controlling the operation of the coating device,
e) wherein the control system only allows the operator access through the access door into the maintenance cabin if at least one of the following conditions is met:
e1) the maintenance window of the maintenance cabin is closed,
e2) the robot in the coating booth is switched off, and/or
f) the control system only allows access through the maintenance window into the maintenance cabin for the robot if the access door to the maintenance cabin is closed.

21. The coating device according to claim 20, wherein the following robots are arranged in the coating booth:
a) at least one coating robot for coating the components with the coating agent, the coating robot guiding an applicator, and
b) at least one handling robot for handling the components to be coated.

22. The coating device according to claim 20, wherein
a) the maintenance cabin comprises a door sensor to detect the opening status of the access door, and
b) the maintenance cabin comprises a controllable door lock which, in a locked state, prevents the access door from being opened, so that the access door can only be opened in an unlocked state,
c) the control system queries the door sensor and controls the door lock in order to control access to the maintenance cabin.

23. The coating device according to claim 20, wherein the maintenance window of the maintenance cabin comprises an adjustable window closure in order to either open or completely or partially close the maintenance window.

24. The coating device according to claim 23, wherein
a) the window closure has a movable or pivotable closure plate which, depending on its position, releases or completely or partially closes the maintenance window, and
b) the movable or pivotable closure plate has a cutout which is adapted to the cross section of a robot arm of the robot, so that the closure plate can close the maintenance window up to the robot arm when the robot arm protrudes into the maintenance cabin through the maintenance window.

25. The coating device according to claim 24, wherein the closure plate is transparent so that an operator can observe processes in the coating booth through the closure plate from the maintenance cabin.

26. The coating device according to claim 24, wherein the closure plate is movable in the vertical direction.

27. The coating device according to claim 23, wherein the control system controls the window closure.

28. The coating device according to claim 24, wherein the cutout in the closure plate tapers starting from the edge of the closure plate.

29. The coating device according to claim 23, wherein
a) the window closure essentially completely releases the maintenance window of the maintenance cabin in an open position, so that the robot with a robot arm can move unhindered through the maintenance window into the maintenance cabin, and
b) the window closure essentially completely closes the maintenance window of the maintenance cabin in a closed position, so that the operator can be in the maintenance cabin while the components are being coated in the coating booth, and
c) in a cleaning position, the window closure covers the maintenance window of the maintenance cabin up to the contour of a robot arm of the robot, so that the robot arm can protrude into the maintenance cabin.

30. The coating device according to claim 20, wherein the access door of the maintenance cabin connects the maintenance cabin with the rest of the coating booth, so that the maintenance cabin can be entered from the interior of the coating booth through the access door.

31. The coating device according to claim 20, wherein the access door of the maintenance cabin connects the maintenance cabin with an outside space outside the coating booth, so that the maintenance cabin can be entered through the access door from outside the coating booth.

32. The coating device according to claim 20, wherein
a) a maintenance device is provided,
b) the maintenance device is pivotably mounted in a pivot opening in a cabin wall of the maintenance cabin by means of a pivoting mechanism,
c) the maintenance device can be pivoted by means of the pivoting mechanism between an operating position within the coating booth and a maintenance position within the maintenance cabin,
d) the pivoting mechanism closes the pivot opening both in the operating position and in the maintenance position.

33. The coating device according to claim 32, wherein the maintenance device is selected from a group consisting of the following maintenance devices:
a) applicator cleaning device for cleaning the applicator,
b) jet testing device for testing the coating agent jets emitted by the applicator designed as a print head,
c) cleaning device for cleaning handling tools of the handling robot.

34. The coating device according to claim 32, wherein
a) the pivoting mechanism has a first closure plate in order to close the pivot opening when the maintenance device is pivoted into the operating position within the coating booth,
b) the pivoting mechanism has a second closure plate in order to close the pivot opening when the maintenance device is pivoted into the maintenance position within the maintenance cabin,
c) the two closure plates of the pivoting mechanism are angled at a fixed angle to one another and pivot together.

35. The coating device according to claim 34, wherein a handle is attached to the maintenance device in order to be able to pull the maintenance device from inside the maintenance cabin into the maintenance cabin.

36. The coating device according to claim 34, wherein the pivoting mechanism has a damper to dampen the pivoting movement of the maintenance device.

37. The coating device according to claim 20, wherein
a) the maintenance cabin has a door opener button to open the access door, and
b) the maintenance cabin has an acknowledgment button to acknowledge the operator leaving the maintenance cabin, and
c) the door opener button and the acknowledgment button are connected to the control system.

38. The coating device according to claim 20, wherein
a) the maintenance cabin can be operated in several different operating modes in order to ensure the safety of the operator during operation, and
b) the maintenance cabin is assigned an operating mode selector switch in order to select the operating mode of the maintenance cabin.

39. The coating device according to claim 38, wherein the maintenance cabin can be operated in at least one of the following operating modes:
a) automatic operation,
b) coating robot cleaning operation for cleaning the coating robot,
c) handling robot cleaning operation for cleaning the handling robot,
d) accessory cleaning operation for cleaning accessories,
e) observation operation for observing processes in the coating booth.

40. The coating device according to claim 39, wherein, in the automatic operation, the control system checks whether there is a maintenance request for a coating robot or a handling robot and when a maintenance request is made, performs some or all of the following steps:
a) terminating the coating operation on the coating robot to be cleaned,
b) discharging the electrostatic coating agent charging system on the coating robot to be cleaned,
c) locking the access door into the maintenance cabin to prevent the access door from being opened and entry into the maintenance cabin,
d) opening the maintenance window of the maintenance cabin,
e) introducing the coating robot or the handling robot through the open maintenance window into the maintenance cabin,
f) closing the maintenance window of the maintenance cabin into the cleaning position,
g) unlocking the access door into the maintenance cabin to allow the operator to enter the maintenance cabin,
h) carrying out a cleaning measure in the maintenance cabin,
i) locking the access door into the maintenance cabin after the operator has left the maintenance cabin and closed the access door,
j) acknowledgment of the locking of the access door into the maintenance cabin by the operator after leaving the maintenance cabin,
k) opening the maintenance window of the maintenance cabin,
l) moving the coating robot or the handling robot out of the maintenance cabin through the open maintenance window,
m) closing the maintenance window of the maintenance cabin.

41. The coating device according to claim 39, wherein, in the coating robot cleaning operation, the control system checks whether there is a user-side cleaning request for a coating robot and, in the event of a cleaning request, some or all of the following steps executes:
a) terminating the coating operation on the coating robot to be cleaned,
b) discharging the electrostatic coating agent charging system on the coating robot to be cleaned,
c) locking the access door into the maintenance cabin to prevent the access door from being opened and entry into the maintenance cabin, provided that the access door is not yet locked,
d) opening the maintenance window of the maintenance cabin,
e) introducing the coating robot to be cleaned through the open maintenance window into the maintenance cabin,
f) closing the maintenance window of the maintenance cabin into the cleaning position,
g) switching off the coating robot,
h) unlocking the access door into the maintenance cabin to allow the operator to enter the maintenance cabin,
i) carrying out a cleaning measure in the maintenance cabin,
j) locking the access door into the maintenance cabin after the operator has left the maintenance cabin and closed the access door;
k) acknowledgment of the locking of the access door into the maintenance cabin by the operator after leaving the maintenance cabin,
l) opening the maintenance window of the maintenance cabin,
m) moving the coating robot out of the maintenance cabin through the open maintenance window,
n) closing the maintenance window of the maintenance cabin.

42. The coating device according to claim 39, wherein, in the handling robot cleaning operation, the control system checks whether there is a user-side cleaning request for a handling robot and if there is a cleaning request performs some or all of the following steps:
a) terminating the current job of the handling robot,
b) Locking the access door into the maintenance cabin to prevent the access door from being opened and entry into the maintenance cabin, provided that the access door is not yet locked,
c) opening the maintenance window of the maintenance cabin,
d) introducing the handling robot to be cleaned through the open maintenance window into the maintenance cabin,
e) switching off the handling robot,
f) closing the maintenance window of the maintenance cabin into the cleaning position,
g) unlocking the access door into the maintenance cabin to allow the operator to enter the maintenance cabin,
h) carrying out a cleaning measure in the maintenance cabin,
i) locking the access door into the maintenance cabin after the operator has left the maintenance cabin and closed the access door,
j) acknowledgment of the locking of the access door into the maintenance cabin by the operator after leaving the maintenance cabin,
k) opening the maintenance window of the maintenance cabin,
l) moving the handling robot out of the maintenance cabin through the open maintenance window,
m) closing the maintenance window of the maintenance cabin.

43. The coating device according to claim 29, wherein the control system carries out the following steps when carrying out the maintenance measure in the maintenance cabin:
a) cleaning the applicator or the robot arm in the maintenance cabin using a cleaning device, and/or
b) placing and/or replacing an external charging ring of the atomizer in the maintenance cabin.

44. The coating device according to claim 39, wherein it is provided in the accessory cleaning operation,
a) the control system pivots the atomizer cleaning device into the maintenance position in the maintenance cabin,
b) the control system unlocks the door lock of the access door of the maintenance cabin in order to allow the operator access to the maintenance cabin.

45. The coating device according to claim 39, wherein it is provided in the observation operation,
a) the control system controls the window closure of the maintenance window of the maintenance cabin in such a way that the window closure assumes the closed position and the maintenance window is completely closed, and
b) the control system unlocks the door lock of the access door of the maintenance cabin to allow the operator access to the maintenance cabin.

46. The coating device according to claim 20, wherein
a) at least one hood opener robot is arranged in an upper level in the coating booth in order to open and close hoods of the motor vehicle bodies,
b) at least one coating robot is arranged in a middle level in the coating booth, and
c) at least one door opener robot is arranged in a lower level in the coating booth in order to open and close doors of the motor vehicle.

47. The coating device according to claim 46, wherein
a) the at least one hood opener robot is movable on an upper travel rail,
b) the at least one coating robot is movable on a middle travel rail, and
c) the at least one door opener robot is movable on a lower travel rail.

48. The coating device according to claim 46, wherein the maintenance window of the maintenance cabin is arranged at such a height that the hood opener robot, the coating robot and the door opener robot can move into the maintenance cabin with a robot arm through the maintenance window.

49. The coating device according to claim 20, wherein
the coating device comprises at least one of the following features:
a) the coating booth has a rectangular floor plan with four corners, with a maintenance cabin being arranged in each of the four corners of the coating booth,
b) the coating robot can be moved or is mounted stationary in the coating booth along a travel rail,
c) the handling robot is movable or mounted stationary in the coating booth along a travel rail,
d) a conveyor is provided to convey the components to be coated through the coating booth,
e) the applicator is an atomizer,
f) a fresh air purging system is provided, which purges the maintenance cabin with fresh air in order to ensure a breathable atmosphere in the maintenance cabin, when the coating agent is applied in the coating booth, a
g) the cabin wall of the maintenance cabin is impermeable to the coating agent,
h) one of the handling robots is a SCARA robot which is designed to open and close doors of the motor vehicle bodies,
i) one of the handling robots is an articulated robot which is designed to open and close hoods of motor vehicle bodies.
